(19) United States
(12) Patent Application Publication
(10) Pub. No.: US 2017/0314683 A1
(43) Pub. Date: Nov. 2, 2017

(54) SEAL ASSEMBLY

(71) Applicant: GM Global Technology Operations LLC, Detroit, MI (US)

(72) Inventor: Jason J. Nolte, Wixom, MI (US)

(21) Appl. No.: 15/144,250

(22) Filed: May 2, 2016

(51) Int. Cl. F16J 15/3284; F16J 15/3216; F16J 15/3212

(52) U.S. Cl. CPC F16J 15/3284; F16J 15/3212; F16J 15/3216

(57) ABSTRACT

A seal assembly is disclosed for providing a seal against a body. The assembly includes an elastically-deformable sealing member with a sealing surface facing a surface of the body. The assembly also includes a shape memory alloy biasing member. The biasing member is configured to bias the sealing surface to different positions with respect to the surface of the body or with different pressures against the surface of the body in response to a displacement response of the shape memory alloy to thermal stimulus. The body can be dynamic relative to the sealing member such as a rotatable shaft, static relative to the sealing member such as a case or housing, or can be either static or dynamic in response to the SMA displacement such as a snubber assembly.

### FIELD OF THE INVENTION

The subject invention relates to seal assemblies and, more specifically, to adjustable seal assemblies.

### BACKGROUND

Various components, including but not limited to rotating shafts, are provided with seals against the components. The seal assembly can be used, for example, to keep external contaminants such as dust away from sensitive or moving components, or to keep fluids such as lubricants, hydraulic fluids, or other materials inside of a component assembly. Various configurations and materials can be utilized to provide a target position of the seal against the body being sealed or to provide a target pressure of the seal against the body being sealed. However, many such configurations and materials are not capable of adjusting the seal position or pressure.

### SUMMARY OF THE INVENTION

In some embodiments, a seal assembly for providing a seal against a body comprises an elastically-deformable sealing member comprising a sealing surface facing a surface of the body. The assembly also includes a biasing member comprising a shape memory alloy. The biasing member is configured to bias the sealing surface to different positions with respect to the surface of the body or with different pressures against the surface of the body in response to a displacement response of the shape memory alloy (SMA) to thermal stimulus. The body can be dynamic relative to the sealing member such as a rotatable shaft, static relative to the sealing member such as a case or housing, or can be either static or dynamic in response to the SMA displacement such as a snubber assembly.

In some embodiments, a method of sealing a body comprises disposing an elastically-deformable sealing member comprising a sealing surface facing a surface of the body. The sealing surface is biased with a biasing member comprising a shape memory alloy to different positions with respect to the surface of the body or with different pressures against the surface of the body in response to a displacement response of the shape memory alloy to thermal stimulus.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1A is a schematic depiction of an example embodiment of a seal assembly in a bias configuration, and FIG. 1B is a schematic depiction of the seal assembly in a different bias configuration;

FIG. 2 is a schematic depiction of an example embodiment of a seal assembly with a coiled biasing member;

FIG. 3A is a schematic depiction of an example embodiment of portion of a seal assembly with a coiled biasing member in a bias configuration, and FIG. 3B is a schematic depiction of the seal assembly portion with the coiled biasing member in a different bias configuration;

FIG. 4 is a schematic depiction of an example embodiment of a seal assembly with nested coiled biasing members;

FIGS. 5A and 5B are schematic depictions of an example embodiment of a seal assembly configured to provide venting;

FIGS. 6A and 6B are schematic depictions of another example embodiment of a seal assembly configured to provide venting;

FIG. 7A is a schematic depiction of another example embodiment of a seal assembly in a bias configuration, and FIG. 7B is a schematic depiction of the seal assembly in a different bias configuration; and

FIG. 8A is a schematic depiction of another example embodiment of a seal assembly in a bias configuration, and FIG. 8B is a schematic depiction of the seal assembly in a different bias configuration.

### DETAILED DESCRIPTION

The following description is merely exemplary in nature and is not intended to limit the present disclosure, its application or uses. For example, the embodiments shown are applicable to vehicle components, but the system disclosed herein may be used with any suitable components to provide securement and retention of mating components and component applications, including many industrial, consumer product (e.g., consumer electronics, various appliances and the like), transportation, energy and aerospace applications, and particularly including many other types of vehicular components and applications, such as various interior, exterior, electrical and under-hood vehicular components and applications. It should be understood that throughout the drawings, corresponding reference numerals indicate like or corresponding parts and features.

Shape memory alloys (SMA's) useful for the biasing members described herein are well-known in the art. Shape memory alloys are alloy compositions with at least two different temperature-dependent phases. The most commonly utilized of these phases are the so-called Martensite and Austenite phases. In the following discussion, the Martensite phase generally refers to the more deformable, lower temperature phase whereas the Austenite phase generally refers to the more rigid, higher temperature phase. When the shape memory alloy is in the Martensite phase and is heated, it begins to change into the Austenite phase. The temperature at which this phenomenon starts is often referred to as Austenite start temperature (Aₛ). The temperature at which this phenomenon is complete is called the Austenite finish temperature (A_{f}). When the shape memory alloy is in the Austenite phase and is cooled, it begins to change into the Martensite phase, and the temperature at which this phenomenon starts is referred to as the Martensite start temperature (Mₛ). The temperature at which Austenite finishes transforming to Martensite is called the Martensite finish temperature (M_{f}). It should be noted that the above-mentioned transition temperatures are functions of the stress experienced by the SMA sample. Specifically, these temperatures increase with increasing stress. In view of the foregoing properties, deformation of the shape memory alloy is preferably at or below the Austenite transition temperature (at or below Aₛ). Subsequent heating above the Austenite transition temperature causes the deformed shape memory material sample to revert back to its permanent shape. Thus, a suitable activation signal for use with shape memory alloys is a thermal activation signal having a magnitude that is sufficient to cause transformations between the Martensite and Austenite phases.

The temperature at which the shape memory alloy remembers its high temperature form when heated can be adjusted by slight changes in the composition of the alloy and through thermo-mechanical processing. In nickel-titanium shape memory alloys, for example, it can be changed from above about 100° C. to below about −100° C. The shape recovery process can occur over a range of just a few degrees or exhibit a more gradual recovery. The start or finish of the transformation can be controlled to within a degree or two depending on the desired application and alloy composition. The mechanical properties of the shape memory alloy vary greatly over the temperature range spanning their transformation, typically providing shape memory effect, superelastic effect, and high damping capacity. For example, in the Martensite phase a lower elastic modulus than in the Austenite phase is observed. Shape memory alloys in the Martensite phase can undergo large deformations by realigning the crystal structure arrangement with the applied stress. As will be described in greater detail below, the material will retain this shape after the stress is removed.

In some embodiments, the biasing member can be an SMA wire or band with two ‘remembered’ lengths. Other configurations can be utilized as well, such as an SMA member that can be transformed between a straight and bent shape, or from one bent shape to a different bent shape. The thermal stimulus to transform an SMA member between different states can be a direct external thermal stimulus, such as heat applied from a heat source like an infrared, convective, or conductive heating element. In many cases, the thermal stimulus can be applied by simply running electrical current through the SMA member to cause it to heat up, and terminating the current so that the SMA member cools down by transferring heat to the surrounding cooler environment.

Suitable shape memory alloy materials for fabricating the biasing member(s) described herein include, but are not intended to be limited to, nickel-titanium based alloys, indium-titanium based alloys, nickel-aluminum based alloys, nickel-gallium based alloys, copper based alloys (e.g., copper—zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and the like. The alloys can be binary, ternary, or any higher order. Selection of a suitable shape memory alloy composition depends on the temperature range where the component will operate. SMA members typically must be worked or trained at different temperatures in order to remember different shapes between the Austenitic and Martensitic states, e.g., by repeated heating and cooling to transition between the Austenitic and Martensitic states combined with cold working of the SMA member. SMA members may exhibit one-way or two-way shape memory depending on the application for which they are intended, and the embodiments disclosed herein may be used with either one-way or two-way SMA members.

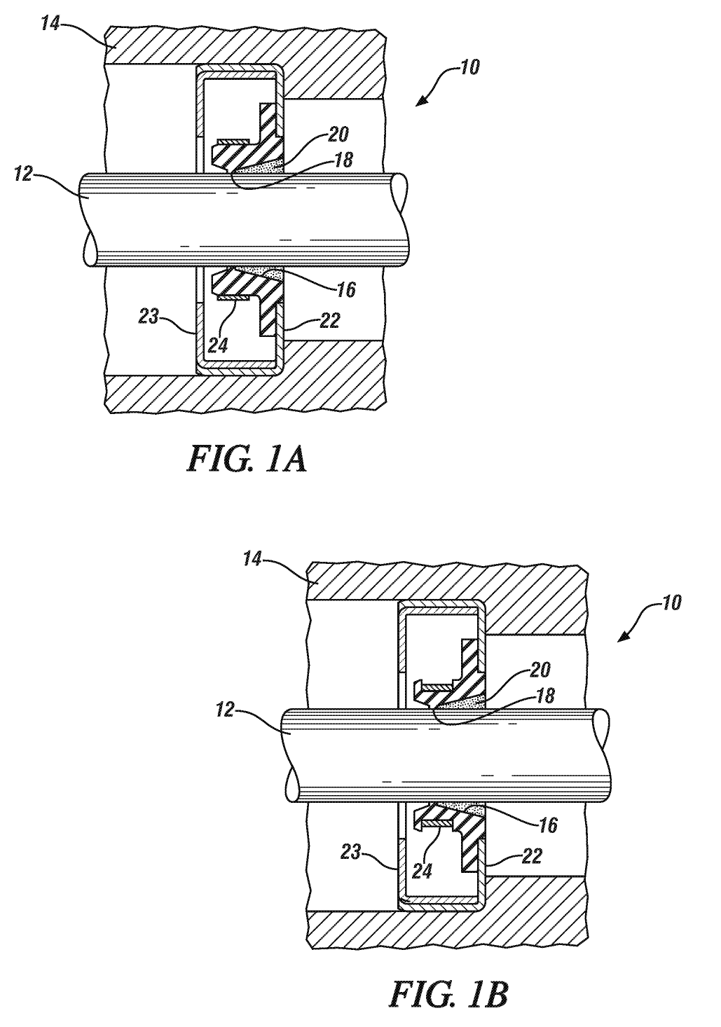

Turning now to the Figures, where numbering is carried through the various Figures to represent identical or similar components without repetition of the description of the same numbering, various example embodiments of seal assemblies are depicted. FIGS. 1A and 1B schematically depict a cross-section view of an example embodiment of a seal assembly 10 for sealing against a body, in this case a rotatable shaft 12, in a housing 14. The seal assembly 10 includes an elastically-deformable sealing member 16, which can be formed of known sealing materials such as rubber or other flexible or resilient polymers, or any other elastically-deformable material suitable for forming a seal. The deformable sealing member includes a lip portion 18 for slideable sealing contact with the rotatable shaft 12 to seal oil 20 onto one side of the sealing member 16 (for example). The sealing member 16 is attached to an outer casing 22, which is in turn attached to the housing 14. An optional outer shield 23 is shown attached to the outer casing 22, which together with the sealing member 16 and outer casing 22 provides an annular cavity for the biasing member and can shield the seal components from external contaminants and debris.

FIGS. 1A and 1B also depict a biasing member as a band 24 of a shape memory alloy that extends circumferentially around an outside surface of the sealing member 16. The SMA band 24 can be configured with two remembered lengths, one of which is a Martensite phase longer length as depicted in FIG. 1A to provide a lower pressure of the seal lip portion 18 against the rotatable shaft 12. As shown in FIG. 1B (e.g., during shaft rotation), the SMA band 24 is heated above a transition temperature, either in response to elevated temperature of the rotating shaft or in response to electrical current from a controller (not shown), causing the SMA band 24 to recover a shorter remembered length (e.g., an Austenite phase) as depicted in FIG. 1B. The shorter band length causes the SMA band 24 to tighten around the sealing member 16 as shown in FIG. 1B, imparting stress through the elastically deformable member 16 to provide a higher pressure of the seal lip portion 18 against the rotatable shaft 12.

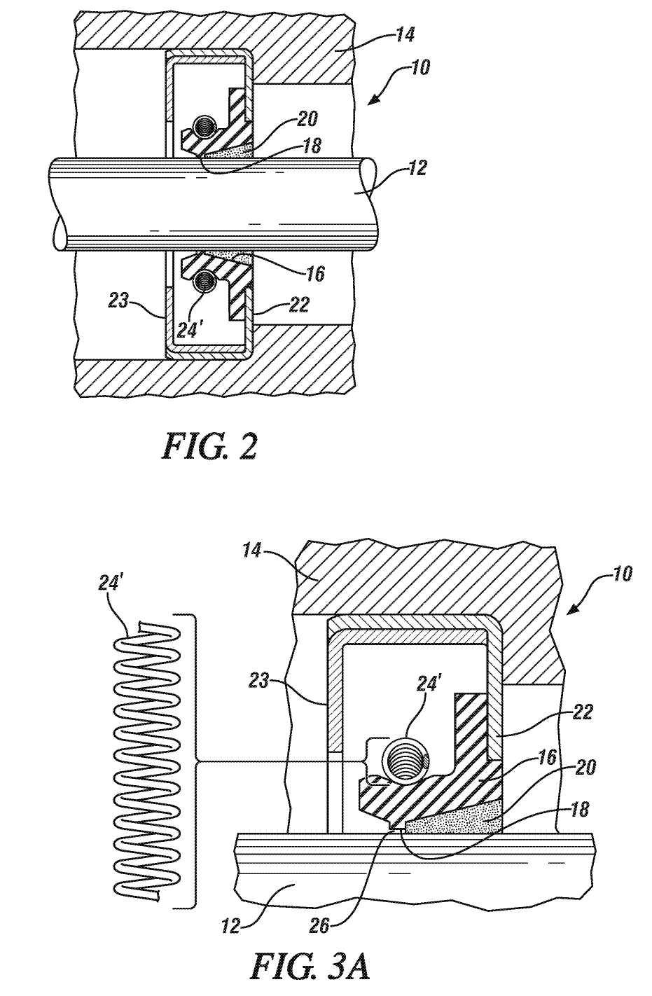

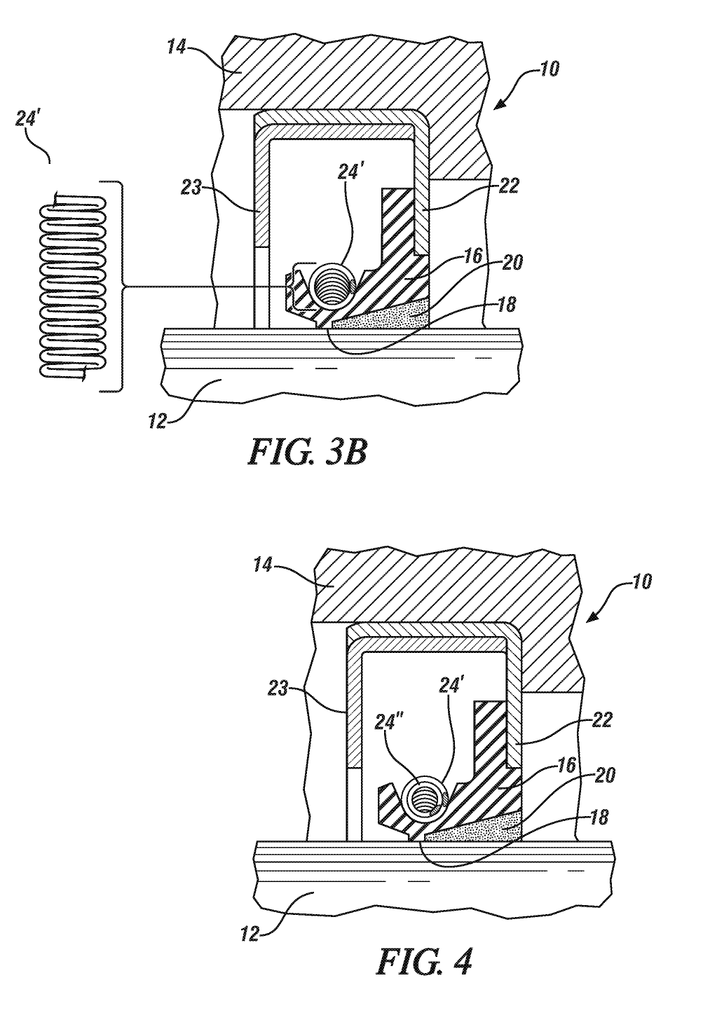

Another example embodiment is depicted in FIG. 2, where an SMA wire coil 24′ is used instead of a band 24. An expanded view of a portion of the seal assembly 10 is shown in FIGS. 3A and 3B. As shown in FIG. 3A, the SMA wire is configured at a longer remembered length (e.g., in a Martensite phase), resulting in a coil 24′ with looser coils and a longer overall coil length. In the configuration depicted in FIG. 3A, the seal lip portion 18 is not in contact with the rotatable shaft 12, and there is a gap 26 between the seal lip portion and the rotatable shaft 12. As shown in FIG. 3B (e.g., during shaft rotation), the SMA wire coil 24′ is heated above a transition temperature, either in response to elevated temperature of the rotating shaft or in response to electrical current from a controller (not shown), causing the SMA wire in then coil 24′ to recover a shorter remembered length (e.g., an Austenite phase) as depicted in FIG. 3B. The shorter wire length causes the SMA coil 24′ to contract to a tighter coil configuration and tighten around the sealing member 16 as shown in FIG. 3B, imparting stress through the elastically deformable sealing member 16 to bias the seal lip portion 18 against the rotatable shaft 12. It should be noted that any of the embodiments depicted can be utilized to bias a sealing member 16 in contact with a rotating shaft 12 to provide different seal pressures against the shaft (e.g., FIGS. 1A and 1B), or to bias the sealing member 16 into different positions with respect to the shaft (e.g., FIGS. 3A and 3B)

The SMA band 24 and SMA wire coil 24′ are examples of particular embodiments of biasing members, and other configurations can be utilized. For example, both the SMA band 24 and SMA wire coil 24′ are configured to distribute stress across a surface area of the sealing member 16. In an alternative configuration, a single SMA wire strand could be circumferentially disposed around an outside surface of the sealing member 16 in conjunction with a non-SMA elastically deformable metal band (configured, for example, in the shape of SMA band 24 as shown in FIGS. 1 and 2) that would deform in response to the SMA wire and distribute the stress along a surface area of the sealing member 16. The SMA wire coil 24′ provides design options for producing different deformation response characteristics compared to a straight band or straight wire SMA biasing member based on the stress absorption and management characteristics of the coil spring structure. Additional tuning of the biasing member deformation response can be obtained by combinations of any of the above or other structures. For example, a plurality of biasing members can be arranged in various configurations, including but not limited to stacked configurations (e.g., parallel SMA biasing coils or bands, or a combination of SMA coils or bands and non-SMA biasing coils or bands, along the circumference of a seal around a rotatable shaft), stacked SMA leaf springs or combinations of SMA leaf springs and non-SMA leaf springs, nested coils, etc.). An example of a nested coil configuration of biasing members is depicted in FIG. 4. FIG. 4 is configured similarly to FIG. 2 and FIGS. 3A and 3B, but with a second wire coil 24″ nested within the wire coil 24′. Either or both of the coils 24′ and 24″ can be formed from SMA wire, and the deformation response of two SMA wires can be complementary, or can work in opposite directions, or can provide deformation responses at different transition temperatures. In some embodiments, one of the coils 24′ and 24″ can be an SMA wire coil that is responsive to the ambient temperature in the seal assembly and the other of the coils 24′ and 24″ can be an SMA wire coil that is responsive to resistance heating from a control signal.

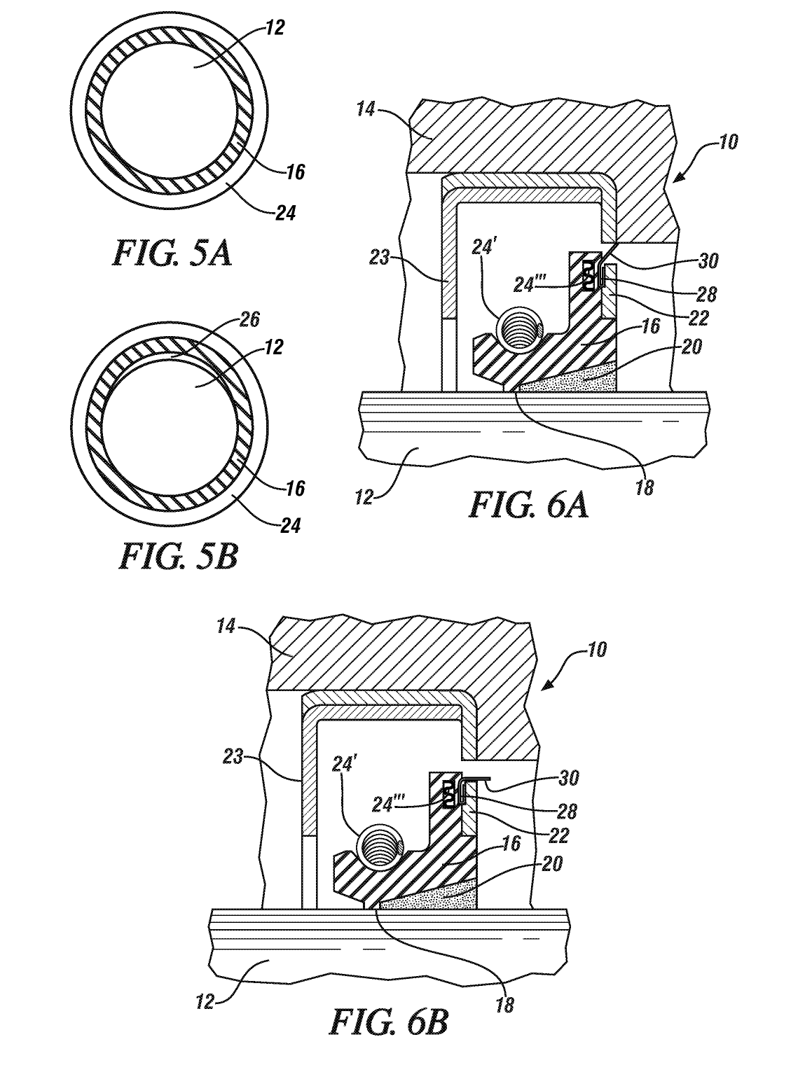

In some embodiments, a biasing member can be configured to provide an asymmetrical deformation response. An asymmetrical deformation response can be utilized for various purposes, such as to provide venting from the area around the sealed body. An asymmetrical SMA displacement response can be provided in a variety of ways. For example, a coil formed from an SMA wire having a uniform deformation response of different lengths can be formed to have a different coil density at different portions along the axis of the coil so that a constant length displacement deformation response along the SMA wire will produce an asymmetrical response of the coil as a whole. Alternatively, an SMA member can produce an asymmetrical response from a compositional variation of the alloy along the length of the SMA member, including a shape memory alloy of varying composition (e.g., Ni—Ti ratio) or having a portion of the biasing member formed from a shape memory alloy and a portion formed from a non-shape memory alloy. An asymmetrical response can also be produced by subjecting different portions of the SMA member to different training schemes, e.g., different portions of the SMA member can be subjected to different degrees of deformation during cold working during the SMA shape training process. Asymmetric biasing of the seal member 16 can also be induced with a biasing member that is disposed only along a portion of the circumference of the seal member 16 instead encircling the seal member. An example embodiment of seal assembly with an asymmetrical deformation response is depicted in FIGS. 5A and 5B. In FIG. 5A, a sealing member 16 is symmetrically disposed around and in sealing contact with a rotatable shaft 12. A biasing member 24 is disposed around the sealing member 16. In FIG. 5B, an asymmetrical deformation response of the biasing member 24 is induced by a thermal stimulus, causing an asymmetrical deformation response in the sealing member 16. The asymmetrical deformation response of the sealing member 16 leaves a gap 26 between the sealing member 16 and the rotatable shaft 12 that allows for venting from the sealed area of the seal assembly, or reduces seal pressure of the sealing member 16 against the rotatable shaft 12 in the area of gap 26 so that any pressurized gas behind the seal can force open the gap 26 to provide the venting. The asymmetrical deformation response depicted in FIG. 5B is an example of regular asymmetry (e.g., a circle deformed to an oval), but irregular asymmetrical responses (e.g., a bulge at a specific point along the seal perimeter) are also contemplated.

An alternative example embodiment to provide venting is shown in FIGS. 6A and 6B. As shown in FIGS. 6A and 6B, an SMA biasing member 24′″ is embedded within the sealing member 16 (e.g., by overmolding), and can be activated by either ambient temperature changes or by a resistance heating from a control signal. The displacement response of the biasing member 24′″ initiates a response from a dynamic reactive surface of snubber assembly 28, which is operatively connected to a valve 30 to move the valve 30 between a closed (i.e., non-vented) position as shown in FIG. 6A and an open (i.e., vented) position as shown in FIG. 6B. The snubber assembly 28 and valve 30 can be configured to provide either an open or closed position response to either a lower bias pressure from the biasing member 24′″ or a higher bias pressure from biasing member 24′″, or vice versa depending on desired system design parameters. Also, although biasing member 24”' is depicted as embedded within the sealing member 16 and biasing members 24, 24′, and 24″ are depicted separately assembled together with the sealing member 16, it should be understood that any biasing member can be embedded (e.g., by overmolding) or separately assembled with other components of the seal assembly.

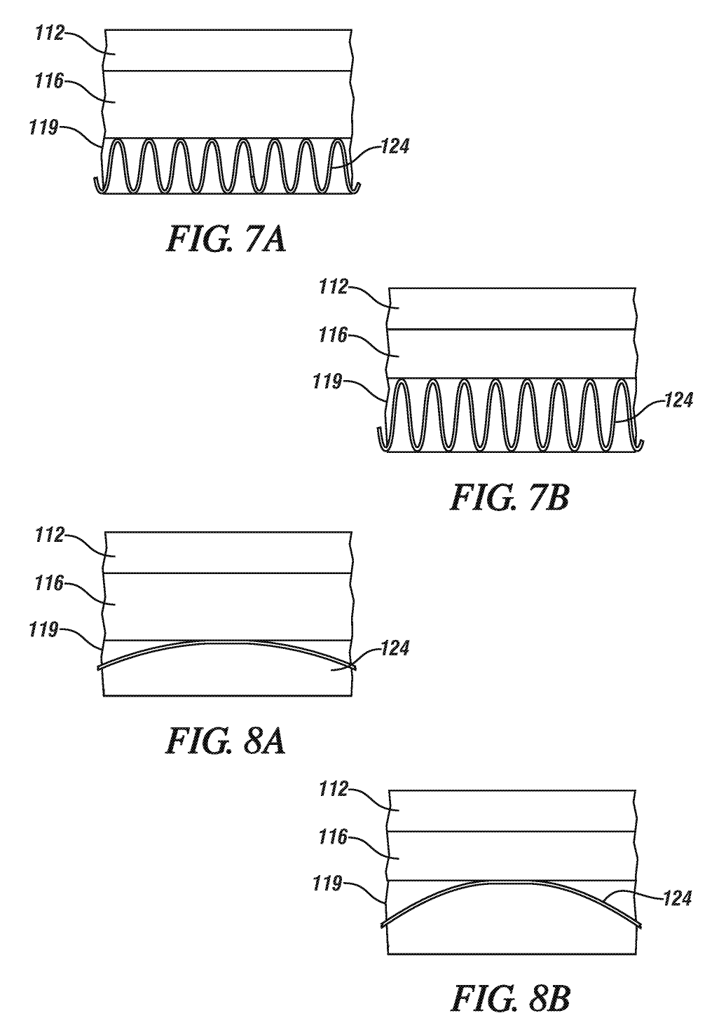

Many of the above-described example embodiments utilize a deformation response of a biasing member where an SMA member length-reducing deformation response of an outer seal around a rotatable shaft provides a tighter seal between a sealing member and the rotatable shaft. A converse configuration can be utilized for inner seal members, where a biasing member disposed radially inwards with respect to the seal can provide a tighter seal with a length-extending deformation response. In other example embodiments, an SMA member length-extending deformation response can be utilized to bias a seal toward a sealed body by utilizing an SMA member (e.g., an SMA wire) configured in a wave or coil pattern that is constrained from axial lengthening so that a length-extending deformation response of the SMA wire produces an expansion of the wave amplitude or coil diameter. Such an example embodiment is depicted in FIGS. 7A and 7B. As shown in FIGS. 7A and 7B, an SMA wire 124 in a wave configuration is disposed in a housing 119 that constrains the SMA wire at the left, right, and bottom ends. The top edge of the SMA wire 124 is disposed against an elastically deformable sealing member 116, which is disposed on an opposite surface against a sealed body 112. In response to a thermal stimulus that induces a length-extending deformation response of the constrained SMA wire 124, the amplitude of the wave pattern increases from the configuration of FIG. 7A to the configuration of FIG. 7B, producing a resulting deformation response of the deformable sealing member 116 to provide increased sealing pressure against the sealed body 112.

Many of the above configurations have utilized an SMA length-altering deformation response to bias a sealing member to different positions with respect to a surface of a sealed body or with different pressures against the surface of the sealed body. However, other deformation responses can be utilized as well, such as different shapes or angles of an SMA biasing member in response to thermal stimulus. An example of such an embodiment is shown in FIGS. 8A and 8B. As shown in FIGS. 8A and 8B, SMA member(s) 124′ are disposed in a leaf spring configuration in a housing 119 that constrains the SMA members at the left and right ends. The top edge(s) of the SMA member(s) 124′ are disposed against an elastically deformable sealing member 116, which is disposed on an opposite surface against a sealed body 112. In response to a thermal stimulus that induces a shape-changing deformation response of the SMA member(s) 124′, a biasing force is imparted against the sealing member 116, and a resulting biasing response of the sealing member 116 provides increased sealing pressure against the sealed body 112.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation of material to the teachings of the invention without departing from the essential scope thereof. Therefore, it is intended that the invention not be limited to the particular embodiments disclosed, but that the invention will include all embodiments falling within the scope of the application.

1. A seal assembly for providing a seal against a body, comprising:
an elastically-deformable sealing member comprising a sealing surface facing a surface of the body; and
a biasing member comprising a shape memory alloy, the biasing member configured to bias the sealing surface to a first position in contact with the surface of the body or to a second position not in contact with the surface of the body in response to a displacement response of the shape memory alloy to thermal stimulus.

2-3. (canceled)

4. The assembly of claim 1, wherein the body comprises a cylindrical shaft, and the sealing member comprises an annular cavity with the biasing member disposed therein.

5. The assembly of claim 4, wherein the shape memory alloy is configured to provide a displacement response providing different circumferential lengths of the biasing member in response to thermal stimulus.

6. The assembly of claim 1, wherein the biasing member comprises a shape memory alloy wire in a coil or wave configuration.

7. The assembly of claim 6, wherein the coil or wave configuration has a restricted axial length, and the shape memory alloy wire is configured to provide a displacement response of different wire length to produce a displacement response of different coil diameter or wave amplitude in response to thermal stimulus.

8. The assembly of claim 1, comprising a plurality of biasing members wherein one or more of the biasing members comprises a shape memory alloy.

9. The assembly of claim 8, comprising a first biasing member that comprises a shape memory alloy configured to produce a displacement response at a first activation temperature, and a second biasing member that comprises a shape memory alloy wire configured to produce a displacement response at a second activation temperature.

10. The assembly of claim 1, wherein the shape memory alloy is configured to provide the displacement response in response to ambient temperature of the seal assembly.

11. The assembly of claim 10, wherein the shape memory alloy is configured to produce a displacement response biasing the sealing surface toward the body in response to higher ambient temperature of the seal assembly.

12. The assembly of claim 1, further comprising a controller configured to provide electric current through the shape memory alloy to provide a controlled thermal stimulus for producing the displacement response.

13. The assembly of claim 12, wherein the biasing member is configured to provide a shape memory alloy displacement response to in response to ambient temperature of the seal assembly or to electric current through the shape memory alloy.

14. The assembly of claim 12, comprising a first biasing member configured to provide a shape memory alloy displacement response to in response to ambient temperature of the seal assembly, and a second biasing member configured to provide a shape memory alloy displacement response in response to electric current through the shape memory alloy.

15. The assembly of claim 12, wherein the body is a rotatable shaft, and wherein the controller and the shape memory alloy are configured to produce a displacement response biasing the sealing surface relatively towards the body in response to an operational condition of the shaft's rotation.

16. The assembly of claim 1, wherein the biasing member is configured to provide venting between the sealing surface and the body in response to a displacement response of the shape memory alloy to thermal stimulus.

17. A method of sealing a body, comprising
disposing an elastically-deformable sealing member comprising a sealing surface facing a surface of the body; and
biasing the sealing surface with a biasing member comprising a shape memory alloy to a first position in contact with the surface of the body or to a second position not in contact with the surface of the body in response to a displacement response of the shape memory alloy to thermal stimulus.

18-19. (canceled)

20. The method of claim 17, further comprising passing electric current through the shape memory alloy to provide the thermal stimulus.

21. The assembly of claim 1, comprising a first biasing member and a second biasing member,
wherein the first biasing member and the second biasing member each comprises a shape memory alloy wire in a coil configuration, and
wherein the second biasing member is nested within the first biasing member.

22. The assembly of claim 21, wherein the displacement response of the first biasing member is at a different temperature than the displacement response of the second biasing member.

23. The method of claim 17, comprising biasing the sealing surface with a first biasing member and a second biasing member,
wherein the first biasing member and the second biasing member each comprises a shape memory alloy wire in a coil configuration, and
wherein the second biasing member is nested within the first biasing member.

24. The method of claim 23, wherein the displacement response of the first biasing member is at a different temperature than the displacement response of the second biasing member.
